(19) United States
(12) Patent Application Publication
(10) Pub. No.: US 2011/0222016 A1
(43) Pub. Date: Sep. 15, 2011

(54) LIQUID CRYSTAL DISPLAY PANEL

(75) Inventors: Hideki Kaneko, Tottori (JP); Koji Yoshida, Tottori (JP); Hiroki Sugiyama, Tottori (JP)

(73) Assignee: SONY CORPORATION, Tokyo (JP)

(21) Appl. No.: 13/039,985

(22) Filed: Mar. 3, 2011

(30) Foreign Application Priority Data
Mar. 10, 2010 (JP) P2010-052785

(51) Int. Cl. G02F 1/1339

(52) U.S. Cl. 349/155

(57) ABSTRACT

A liquid crystal display panel includes: one pair of substrates each of which is disposed so as to face each other with a liquid crystal layer pinched therebetween; alignment films that are formed on opposing faces of the one pair of substrates with the liquid crystal layer pinched therebetween; a plurality of columnar spacers that are formed in a display area on one side of the one pair of substrates and maintain a cell gap between the one pair of substrates; and a light shielding member that is formed on one side of the one pair of substrates of a non-opening portion including a spot at which the columnar spacers are formed.

### CROSS REFERENCES TO RELATED APPLICATIONS

The present application claims priority to Japanese Priority Patent Application JP 2010-052785 filed in the Japan Patent Office on Mar. 10, 2010, the entire contents of which is hereby incorporated by reference.

### BACKGROUND

The present application relates to a liquid crystal display panel of a horizontal electrical field type using columnar spacers, and more particularly, to a liquid crystal display panel of a horizontal electric field type, which has a high aperture ratio and superior impact characteristics at low temperatures, using two or more types of columnar spacers having different heights.

Recently, as display devices of electronic apparatuses such as personal computers, cellular phones, and other mobile information terminals, liquid crystal display panels have become widely used. These liquid crystal display panels have a configuration in which one pair of substrates are used, each having opposing faces on which predetermined electrode patterns, a color filter layer, and the like are formed, one substrate of the pair of substrates is coated with a sealing member, both substrates are bonded together so as to form a space having a predetermined width therebetween, and a liquid crystal is enclosed between both the substrates.

In the liquid crystal display panel, in order to maintain a predetermined gap between one pair of substrates, that is, a cell gap, to be constant, spacers are interposed between both of the substrates. As the spacers of a liquid crystal display panel in related art, spherical spacers acquired by processing resin or silica particles in a spherical shape are used. However, it is difficult to uniformly spread the spherical spacers on a spreading surface at the time of spreading, and there are problems that the spherical spacers are positioned at opening portions of the liquid crystal display panel so as to decrease the aperture ratio of the liquid crystal display panel and the like. Accordingly, recently, instead of the spherical spacers, columnar spacers are used.

In the columnar spacers, as the density of the columnar spacers disposed within a display area is increased, the characteristics for maintaining the cell gap is improved, but there is a problem in that air bubbles may be easily generated in an impact test at low temperatures. An impact test at low temperatures is performed to assure the product quality of the liquid crystal display panel in a low-temperature environment. In the impact test at low temperatures, the liquid crystal display panel is maintained in a low-temperature environment of about −20° C., and thereafter, an impact is applied to the display surface thereof so as to check the degree of generation of air bubbles.

In order to solve such a problem, in a liquid crystal display panel disclosed in JP-A-2003-121857, a so-called two-level spacer configuration is employed in which first columnar spacers having a large height and second columnar spacers having a small height are formed on a color filter substrate. In this liquid crystal display panel, when high pressure is locally applied between both the substrates, first, the first columnar spacers having the large height that are consistently brought into contact with an opposing array substrate are pressed, and then the second columnar spacers having the small height that are normally separated from the array substrate are brought into contact with the array substrate, so that the second columnar spacers take most of the strong force.

Thus according to the liquid crystal display panel disclosed in JP-A-2003-121857, even in a case where a strong force is applied to the liquid crystal display panel, the first columnar spacers are prevented from being excessively deformed by excessive deformation. Accordingly, when high pressure disappears, the first and second columnar spacers are returned to their original states, whereby the cell gap between the array substrate and the color filter substrate is maintained to be constant. Furthermore, even when the liquid crystal is contracted by placing the liquid crystal display panel in a low-temperature environment, owing to the placement of the second columnar spacers having the small height, the deformation of the array substrate and the deformation of the color filter substrate can be followed by each other. Accordingly, an advantage whereby generation of low-temperature air bubbles is suppressed can be acquired as well.

In addition, a liquid crystal display panel disclosed in JP-A-2006-058894 employs a configuration in which columnar spacers having two differing heights are placed. This liquid crystal display panel is configured by two types of the columnar spacers including first columnar spacers having a height and a cross-sectional area corresponding to the deformation due to the load at the time of panel assembly and deformation following the contraction of the liquid crystal when in low temperatures and second columnar spacers having a height and a cross-sectional area for maintaining a gap between the substrates at the time of the application of an excessive load or at the time of contraction of the liquid crystal in a low-temperature environment. According to the liquid crystal display panel disclosed in JP-A-2006-058894, by employing a spacer configuration having two differing heights, generation of vacuum air bubbles in a liquid crystal layer in a low-temperature environment is suppressed. In addition, by configuring the cross-sectional area of the second columnar spacer to be relatively large, the cell gap is stabilized, thereby improving the resistance to impact.

In addition, in JP-A-9-073088, an example is presented in which a light leakage phenomenon due to skidding of the columnar spacers is prevented. More specifically, an array substrate having a first portion (for example, a pixel electrode) and a second portion (for example, a signal line forming portion) that is lower than the first portion is included, and by bringing the columnar spacers into contact with the second portion that is lower than the first portion of the array substrate, even in a case where the columnar spacers skid in accordance with an external force, the columnar spacers can easily return to their original positions when the external force is eliminated.

### SUMMARY

When a strong force is applied to the substrates, the front end portion of the columnar spacer is brought into contact with an alignment film regardless of the shape of the columnar spacer. At that time, as is also suggested in JP-A-9-073088, the front end portion may move so as to rub the surface of the alignment film that is in contact with the front end portion. Accordingly, there are cases where there is alignment disturbance on the periphery of the columnar spacers, and leakage of light occurs. Especially, this phenomenon markedly appears in a liquid crystal display panel of a horizontal electric-field type such as an In-Plane Switching (IPS) mode or an Fringe Field Switching (FFS) mode. This phenomenon will be described with reference to FIGS. 7A to 7D. FIGS. 7A to 7D are schematic diagrams illustrating a mechanism of the leakage of light occurring due to bending.

A liquid crystal display panel 50 of the horizontal electric-field type includes an array substrate AR, a color filter substrate CF, and a liquid crystal LC that is injected between the above-described substrates. In the array substrate AR, an interlayer film, predetermined patterns of a pixel electrode and a common electrode, an insulating film (all not shown in the figure), and the like are disposed on a transparent substrate 51, and an alignment film 52 is formed on the uppermost face on the liquid crystal LC side. In the color filter substrate CF, a color filter layer 55 is disposed on a transparent substrate 53 while being partitioned by a light shielding member 54, and an over-layer 56 and an alignment film 57 are formed on the color filter layer 55 in the mentioned order, so that the alignment film 57 is on the liquid crystal LC side.

A columnar spacer 58, for example, is configured as a columnar body, which has a predetermined length and a predetermined thickness, disposed on the over-layer 56 of the color filter substrate CF. In the columnar spacer 58, a base portion 58a is fixed to a spot of the surface of the over-layer 56 at which the light shielding member 54 of the color filter substrate CF is disposed, and a front end portion 58b corresponding to a top portion is brought into contact with the surface of the alignment film 52 of the array substrate AR through the alignment film 57, whereby a constant cell gap is maintained between the array substrate AR and the color filter substrate CF.

When high pressure P is locally applied to one end of the color filter substrate CF, for example, the left side in FIG. 7A during manufacturing or using the liquid crystal display panel 50 or the like, the color filter substrate CF swings as shown in FIG. 7B such that the left side is pushed so as to be lowered, and the right side is lifted up with the columnar spacer 58 used as a support axis. When higher pressure P is applied, it is difficult for the base portion 58a of the columnar spacer 58 fixed to the color filter substrate CF to move, and the front end portion 58b of the columnar spacer 58 moves toward the right side as denoted by an arrow shown in FIG. 7C while rubbing the surface of the alignment film 52. FIG. 7C represents a state in which the front end portion 58b of the columnar spacer 58 maximally moves toward the right side.

Thereafter, when the pressure applied to the color filter substrate CF disappears, the color filter substrate CF is returned to its original state in accordance with the restoring force thereof, and the columnar spacer 58 is returned to its original position as well. However, even when the columnar spacer 58 is returned to its original position, a trace of rubbing of the columnar spacer 58 remains on the surface of the alignment film 52. The length W of the trace may be greater than the width of the light shielding member 54 at a spot to which the base portion 58a of the columnar spacer 58 is fixed.

The distance W1 shown in FIG. 7D represents the length of the trace portion in a portion exceeding the light shielding member 54 in the plan view. Accordingly, light L emitted from a back light (not shown in the figure) that is disposed on the rear face of the array substrate AR may be transmitted through the trace portion so as to appear on a display screen, thereby degrading the display quality. When the length of the trace portion is great, disturbance in the alignment occurs so as to cause a similar degradation of the quality. It is understood that such a phenomenon similarly occurs when high pressure is locally applied to the columnar spacer having the small height that is normally separated from the color filter substrate, and, in a case where the columnar spacer is fixed to the array substrate side, it is understood that this is a phenomenon similar to that occurring in the alignment film on the color filter substrate side occurs.

In order to prevent the degradation of the display quality due to skidding of the above-described columnar spacer on the surface of the alignment film, which is caused by the leakage of light, in a liquid crystal display panel in related art, the light shielding member with which the columnar spacer is coated in the plan view is formed to have a width sufficiently larger than the width of the columnar spacer based on the prediction of rubbing of the alignment film of the opposing substrate with the columnar spacer. Also, in the liquid crystal display panels, which are represented in JP-A-2003-121857 and JP-A-2006-058894, using two types of columnar spacers having different heights, when high pressure is locally applied, the degree of rubbing the alignment film of the opposing substrate with the columnar spacer having the small height is understood to be the same as that of the columnar spacer having the large height. Therefore, the light shielding member having a sufficient width for all the columnar spacers is disposed.

However, recently, a liquid crystal panel used in a mobile terminal or the like demands a high resolution, high luminance, and low power consumption in addition to miniaturization. Accordingly, it is necessary to increase the aperture ratio of the panel. Thus, a place (a non-opening portion) in which the spacers are disposed becomes insufficient. Therefore, it is extremely difficult to dispose spacers having a large diameter in a pixel area without decreasing the aperture ratio. In addition, in a liquid crystal display panel having the two-level spacer configuration in related art, the number of the columnar spacers is increased, and there is a problem in that the aperture ratio decreases in proportion to the increase in the number of the columnar spacers.

The inventors of the present application have wholeheartedly performed research repeatedly on the configuration of a two-level spacer liquid crystal display panel that can sufficiently suppress the leakage of light due to skidding of the columnar spacers on the surface of the alignment film without decreasing the aperture ratio. As a result, since the possibility of the occurrence of the leakage of light due to rubbing of the alignment film of the opposing substrate with the columnar spacers having a small height is lower than that in a case of the columnar spacers having a large height, a technology for setting the light shielding area of the columnar spacers having a small height to be less than that of the columnar spacer having a large height in the plan view has been sought, thereby accomplishing embodiments of the present application.

That is, the present application is addressed to provide a liquid crystal display panel, which includes columnar spacers having a large height and columnar spacers having a small height, capable of suppressing the leakage of light and disturbance in the alignment due to rubbing the surface of the alignment film with the columnar spacers and improving the aperture ratio.

According to an embodiment, there is provided a liquid crystal display panel including: one pair of substrates each of which is disposed so as to face each other with a liquid crystal layer pinched therebetween; alignment films that are formed on opposing faces of the one pair of substrates with the liquid crystal layer pinched therebetween; a plurality of columnar spacers that are formed in a display area on one side of the one pair of substrates and maintain a cell gap between the one pair of substrates; and a light shielding member that is formed on one side of the one pair of substrates of a non-opening portion including a spot at which the columnar spacers are formed. The columnar spacers include a first columnar spacer that is disposed such that a front end portion of the first columnar spacer is normally brought into contact with the other side of the one pair of substrates and a second columnar spacer, which is lower than the first columnar spacer, having a front end portion that is normally separated from the other side of the one pair of substrates by a constant distance and is brought into contact with the other side of the one pair of substrates at time of application of pressure to one substrate of the one pair of substrates, and the light shielding member is formed such that a shortest distance between the second columnar spacer and a peripheral edge portion of the light shielding member in the plan view is shorter than a shortest distance between the first columnar spacer and the peripheral edge portion of the light shielding member in the plan view.

In the above-described liquid crystal display panel, the columnar spacers include a first columnar spacer, which has a large height, disposed such that the front end portion of the first columnar spacer is normally brought into contact with the other side of the one pair of substrates and a second columnar spacer, which has a small height, having the front end portion that is normally separated from the other side of the one pair of substrates by a constant distance and is disposed so as to be brought into contact with the other side of the one pair of substrates at time of application of pressure, equal to or higher than predetermined pressure, to one of the one pair of substrates. In such a configuration, when high pressure is locally applied to the one pair of substrates, first, the first columnar spacer, which has the large height, consistently being brought into contact with the opposing substrate is pressed, and then the second columnar spacer, which has the small height, normally separated from one of the substrates is brought into contact with the one of the substrates, whereby the liquid crystal display panel can withstand a more stronger force. In addition, even in a case where a total number of the first columnar spacer and the second columnar spacer is increased, the front end portion of the second columnar spacer is normally separated from the other side of the one pair of the substrates by a constant distance, whereby good air bubble impact characteristics at low temperatures can be maintained.

In addition, in the above-described liquid crystal display panel, the light shielding member is formed such that a shortest distance between the second columnar spacer and a peripheral edge portion of the light shielding member in the plan view is shorter than a shortest distance between the first columnar spacer and the peripheral edge portion of the light shielding member in the plan view. Since the front end portion of the second columnar spacer is normally separated from the other side of the one pair of substrates by a constant distance, a light leaking area that is generated by rubbing the alignment film on the other side of the one pair of substrates with the front end portions is smaller than that of the case of the first columnar spacer. Thus, according to the above-described liquid crystal display panel, the area in which the light shielding film is formed in a portion in which the second columnar spacer is disposed can be decreased. Accordingly, the above-described liquid crystal display panel can improve the aperture ratio to be higher than that of a two-level spacer configuration in related art while the advantage of suppressing the leakage of light, which is the same as the liquid crystal display panel having the two-level spacer configuration in related art is, acquired.

In addition, in the above-described liquid crystal display panel, a pixel electrode and a common electrode may be formed below the alignment film on one substrate of the one pair of substrates.

The liquid crystal display panel in which the pixel electrode and the common electrode are formed on one substrate side of the alignment film disposed on one of the one pair of the substrates is a horizontal electric-field type. In the liquid crystal display panel of the horizontal electric-field type, compared to a case of a liquid crystal display panel of the vertical electric-field type, the leakage of light due to rubbing the surface of the alignment film with the columnar spacer may easily occur. Therefore, according to the above-described liquid crystal display panel, even in a case where liquid crystal display panel of the horizontal electric-field type is used, the aperture ratio can be improved to be higher than that of the two-level spacer configuration in related art while the same advantage of suppressing the leakage of light as the two-level spacer configuration in related art is acquired.

In addition, in the above-described liquid crystal display panel, it is preferable that the pixel electrode and the common electrode are formed in a state of being insulated from each other with an inter-electrode insulating film pinched therebetween, and a slit-shaped opening is formed in one electrode of either the pixel electrode or of the common electrode that is closer to the alignment film. In such a case, in the above-described liquid crystal display panel, it is preferable that one electrode of either the pixel electrode or of the common electrode that is disposed on one substrate side of the inter-electrode insulating film is formed on an interlayer resin film that is formed on the one of the one pair of substrates.

The liquid crystal display panel of the horizontal electric-field type, in which the pixel electrode and the common electrode are formed in a state of being insulated from each other with an inter-electrode insulating film pinched therebetween, and a slit-shaped opening is formed in one electrode of either the pixel electrode or of the common electrode that is closer to the alignment film, operates in the FFS mode. In the liquid crystal display panel of the FFS mode, since an upper electrode and a lower electrode are formed to be laminated with an inter-electrode insulating film, which is formed on one side of the one pair of substrates, interposed therebetween, a concave-convex is formed on the surface of the alignment film. Accordingly, after the alignment film is rubbed, particularly, disturbance in the alignment may easily occur, whereby leakage of light may easily occur. Thus, according to the above-described liquid crystal display panel, even in the liquid crystal display panel of the FFS mode, the aperture ratio can be improved to be higher than that of the liquid crystal display panel having the two-level spacer configuration in related art while the same advantage of suppressing the leakage of light as that of the liquid crystal display panel having the two-level spacer configuration in related art is acquired.

In addition, the liquid crystal display panel of the FFS mode having an interlayer resin film has air bubble impact characteristics at low temperatures that are degraded, compared to the liquid crystal display panel of the FFS mode not having the interlayer resin film. According to the above-described liquid crystal display panel, the two-level columnar spacers are used, and accordingly, good air bubble impact characteristics at low temperatures can be maintained also in the liquid crystal display panel of the FFS mode having the interlayer resin film. In addition, the aperture ratio can be improved to be higher than that of the liquid crystal display panel having the two-level spacer configuration in related art while the same advantage of suppressing the leakage of light as that of the liquid crystal display panel having the two-level spacer configuration in related art is acquired.

In addition, in the above-described liquid crystal display panel, it is preferable that a shortest distance between a peripheral edge portion of the light shielding member, with which the second columnar spacer is coated, and the second columnar spacer in the plan view is set to be shorter than a shortest distance between a peripheral edge portion of the light shielding member, with which the first columnar spacer is coated, and the first columnar spacer in the plan view by a distance that is equal to or greater than 2 μm and is equal to or less than 6 μm.

By designing a light shielding member that coats the first and second columnar spacers to be formed, the possibility that leakage of light occurs due to rubbing of the alignment film on the opposing substrate with the second columnar spacers is avoided, and the aperture ratio near the second columnar spacer can be improved.

In addition, in the above-described liquid crystal display panel, it is preferable that a cross-sectional area of the second columnar spacer is larger than a cross-sectional area of the first columnar spacer.

The “cross-sectional area of the columnar spacer” in the embodiment means a cross-sectional area in the direction parallel to the color filter substrate CF. When the cross-sectional area of the second columnar spacer is larger than that of the first columnar spacer, the second columnar spacer can withstand an external force more than the first columnar spacer. Therefore, the above-described liquid crystal display panel can withstand a relatively strong external force, compared to a case where the cross-sectional area of the second columnar spacer is configured to be the same as that of the first columnar spacer, while the above-described advantages according to the embodiment is acquired.

In addition, in the above-described liquid crystal display panel, it may be configured such that a plurality of the second columnar spacers are provided and each of the second columnar spacers having the same height, and a total cross-sectional area of the plurality of columnar spacers is set to be larger than the cross-sectional area of the first columnar spacer.

In a case where the second columnar spacer is formed from a plurality of columnar spacers having the same height, even when the shortest distance between each columnar spacer and the peripheral edge portion of the light shielding member in the plan view is the same as that of one second columnar spacer, the area occupied by the surrounding light shielding member of the second columnar spacer can be decreased. Therefore, according to the above-described liquid crystal display panel, the aperture ratio near the second columnar spacers can be improved further.

Additional features and advantages are described herein, and will be apparent from the following Detailed Description and the figures.

### BRIEF DESCRIPTION OF THE FIGURES

FIG. 1 is a plan view showing a schematic configuration of a liquid crystal display panel that is common to first and second embodiments.

FIG. 2 is a plan view of one sub pixel of the liquid crystal display panel shown in FIG. 1.

FIG. 3 is a cross-sectional view taken along line III-III shown in FIG. 2.

FIG. 4 is a plan view of one pixel (three sub pixels) of a liquid crystal display panel according to the first embodiment.

FIG. 5 is a schematic cross-sectional view taken along line V-V shown in FIG. 4.

FIG. 6 is a plan view of one pixel (three sub pixels) of a liquid crystal display panel according to the second embodiment.

FIGS. 7A to 7D are schematic diagrams illustrating a mechanism of occurrence of the leakage of light due to bending.

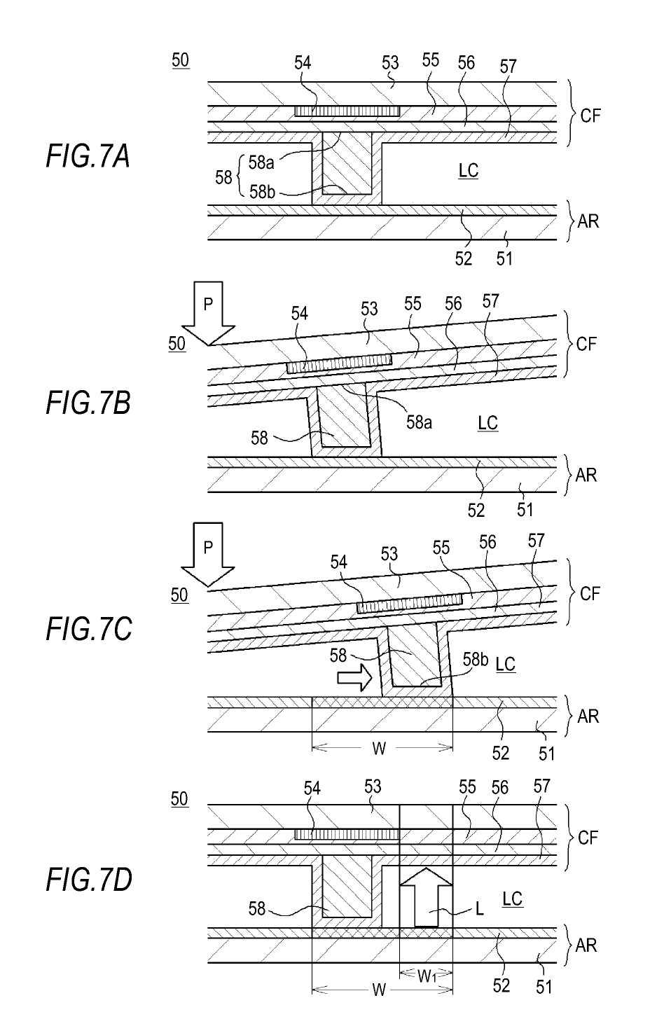

### DETAILED DESCRIPTION

Embodiments of the present application will be described below in detail with reference to the drawings.

However, in the embodiments described below, an FFS-mode liquid crystal display panel for embodying the technical idea of embodiments of the present application is described as an example. Thus, the embodiments are not for the purpose of limiting the present application to the FFS-mode liquid crystal display panel, and the present application can be also applied to other embodiments belonging to the scope of the present application defined by the claims. In the drawings used for the description here, in order to scale each layer or each member so as to be recognizable in the drawings, the layers and members are represented in different scales, and thus the layers and the members are not represented in proportion to the actual sizes thereof.

### First Embodiment

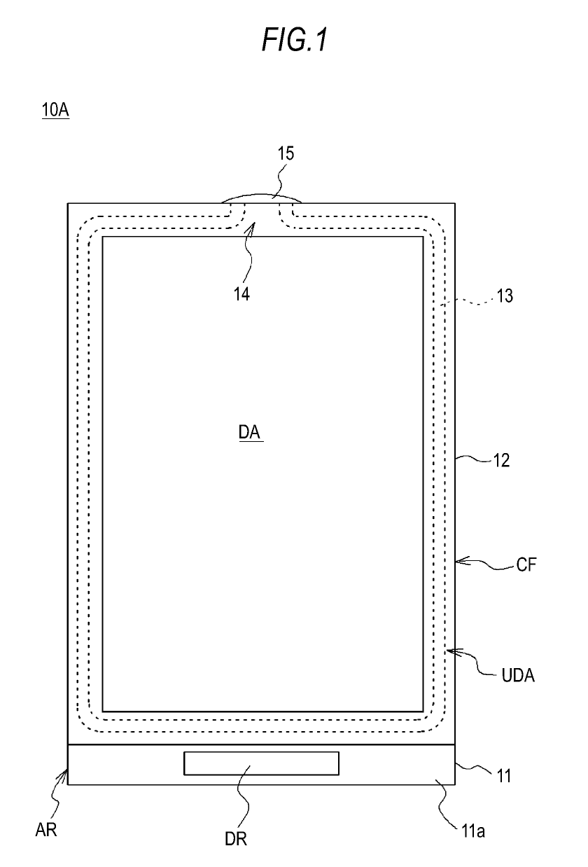

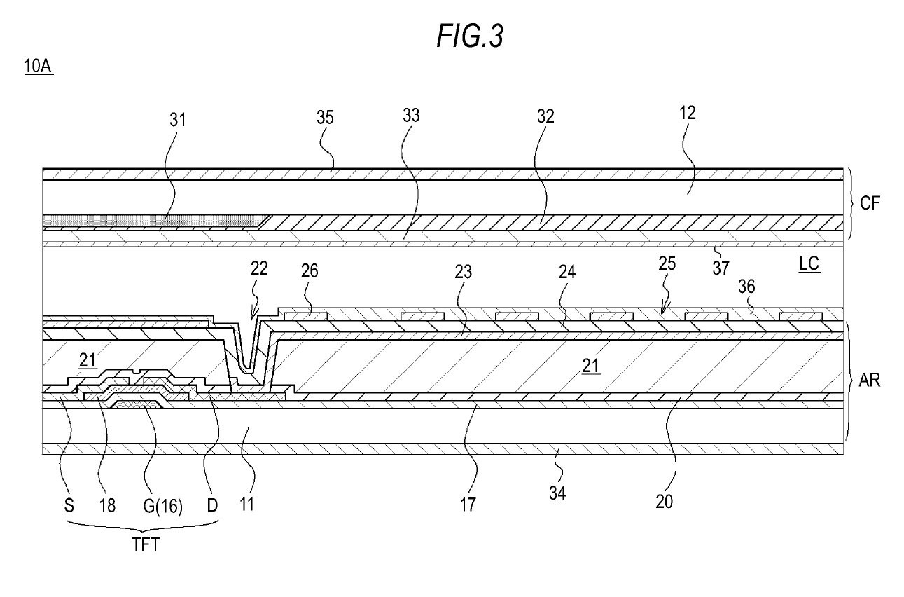

First, the configuration of a liquid crystal display panel 10A according to a first embodiment will be described with reference to FIGS. 1 to 5. As shown in FIG. 1, in the liquid crystal display panel 10A according to the first embodiment, an array substrate AR acquired by forming various wirings and the like on a first transparent substrate 11 formed from glass or the like and a color filter substrate CF acquired by forming a color filter layer and the like on a second transparent substrate 12 formed from glass or the like are disposed so as to face each other. The array substrate AR and the color filter substrate CF are bonded together with a sealing member 13, and a liquid crystal LC (see FIG. 3) is enclosed inside a space that is formed by the sealing member 13. In addition, a gap (cell gap) between the array substrate AR and the color filter substrate CF is formed to be a constant distance in accordance with columnar spacers. A specific disposition of the columnar spacers and the configuration of the columnar spacers will be described later.

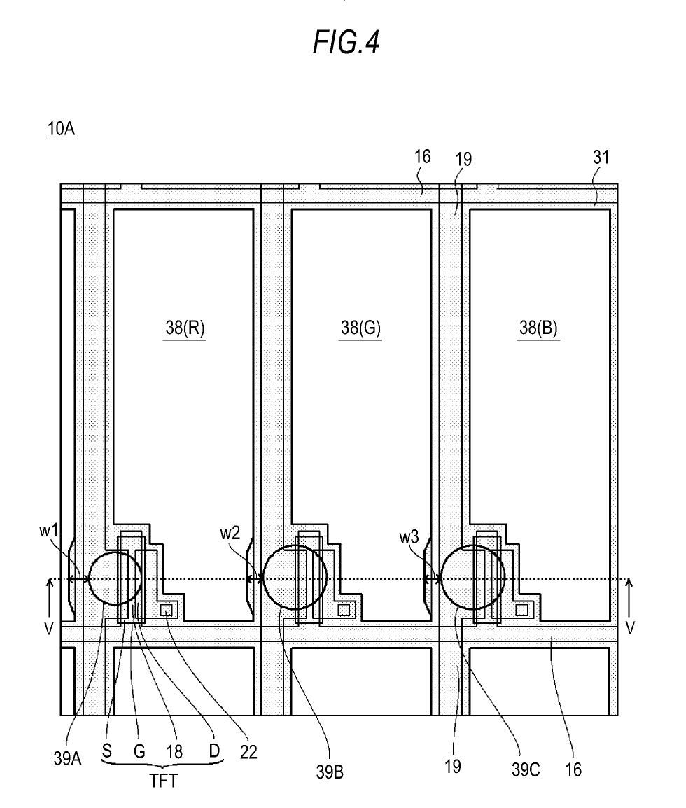

In addition, on the inner side of an area surrounded by the sealing member 13, for example, a plurality of unit pixels each formed, for example, from adjacent sub pixels 38(R), 38(G), and 38(B) (see FIG. 4) of three colors including red (R), green (G), and blue (B) are formed and a display area DA in which the unit pixels are disposed in a matrix shape is formed. On the outer peripheral side of the display area DA and on the outer peripheral side of the sealing member 13, a non-display area UDA (it is also referred to as a “frame area”) is formed. In addition, in the display area DA positioned on the inner side of the area surrounded by the sealing member 13 and the non-display area UDA, the liquid crystal LC is disposed.

In addition, the array substrate AR having a size slightly larger than that of the color filter substrate CF is used so as to form a portion having a predetermined area when the array substrate AR is disposed so as to face the color filter substrate CF. The portion serves as a mounting area 11a in which integrated circuits DR such as drivers used for driving the liquid crystal LC and the like are disposed. In the liquid crystal display panel 10A according to the first embodiment, an example is shown in which a liquid crystal injecting opening 14 is formed by the sealing member 13, and the liquid crystal injecting opening 14 is sealed by a sealing member 15.

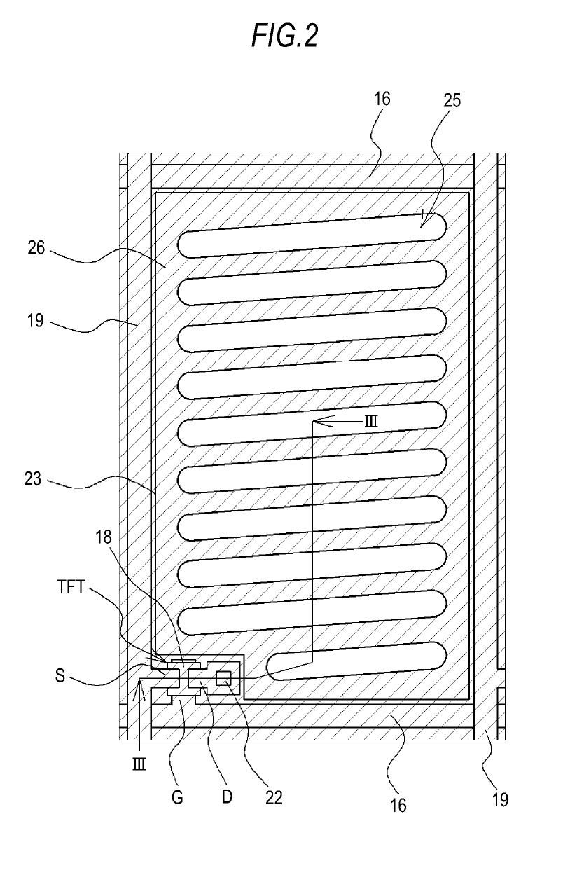

Next, the configuration of each substrate will be described with reference to FIGS. 2 and 3. FIG. 2 is a plan view of one sub pixel of the liquid crystal display panel shown in FIG. 1. FIG. 3 is a cross-sectional view taken along line III-III shown in FIG. 2.

First, in the array substrate AR, a plurality of scanning lines 16 including a gate electrode G that is, for example, formed from a two-layer wiring of Mo/Al are formed on the surface of the first transparent substrate 11 so as to be parallel to one another. In addition, the entirety of the surface of the first transparent substrate 11 on which the scanning lines 16 are formed is coated with a gate insulating film 17 that is formed from a transparent insulating material such as silicon nitride or silicon oxide. In addition, in an area of the surface of the gate insulating film 17 in which a thin film transistor TFT as a switching element is formed, a semiconductor layer 18 that is, for example, formed from an amorphous silicon layer is formed. The area of the scanning lines 16 at a position at which the semiconductor layer 18 is formed forms the gate electrode G of the thin film transistor TFT.

In addition, on the surface of the gate insulating film 17, a signal line 19 including a source electrode S that is, for example, formed from a conductive layer having a three-layer structure of Mo/Al/Mo and a drain electrode D are formed. Both the source electrode S portion and the drain electrode D portion of the signal line 19 partially overlap the surface of the semiconductor layer 18. In addition, the entirety of the surface of the array substrate AR is coated with a passivation film 20 that is formed from a transparent insulating material such as silicon nitride or silicon oxide. In addition, the entirety of the surface of the passivation film 20 is coated with an interlayer film 21 that is, for example, formed from a resin material. In the passivation film 20 and the interlayer film 21 located at a position corresponding to the drain electrode D, a contact hole 22 is formed.

On the interlayer film 21 in the areas of sub pixels 38(R), 38(G), and 38(B) surrounded by the scanning lines 16 and the signal lines 19, a lower electrode 23 is formed from a transparent conductive material that is, for example, formed from Indium Tin Oxide (ITO) or Indium Zinc Oxide (IZO) so as to form a pattern shown in FIG. 2. This lower electrode 23 is electrically connected to the drain electrode D through the contact hole 22. Accordingly, the lower electrode 23 serves as a pixel electrode. In addition, on the lower electrode 23, an inter-electrode insulating film 24 is formed. The inter-electrode insulating film 24 is formed by using a transparent insulating material such as silicon nitride that has a good insulating property.

On the inter-electrode insulating film 24, an upper electrode 26 having a plurality of slit-shaped openings 25, for example, each having a bar shape in the plan view in the areas of the sub pixels 38(R), 38(G), and 38(B) is formed by using a transparent conductive material that is formed from ITO or IZO. A predetermined alignment film (not shown in the figure) is formed over the entirety of the surface of the substrate. The upper electrode 26 is formed so as to extend over the entirety of the display area DA and is electrically connected to a common wiring (not shown in the figure) in the non-display area UDA. Accordingly, the upper electrode 26 serves as a common electrode. The surface of the upper electrode 26 and the exposed surface of the inter-electrode insulating film 24 are coated with a first alignment film 36.

In addition, in the color filter substrate CF, as shown in FIG. 3, a light shielding member 31 is formed on the surface of the second transparent substrate 12, which is formed from a glass substrate or the like, so as to coat a portion of the surface of the second transparent substrate 12 corresponding to the scanning line 16, the signal line 19, the thin film transistor TFT, and the non-display area UDA of the array substrate AR. The light shielding member 31, for example, is formed from a resin material mixed with a metal material such as chromium, an opaque pigment, and the like.

In addition, on the surface of the second transparent substrate 12 on which the light shielding member 31 is formed, a color filter layer 32 of a plurality of colors, for example, three colors including red (R), green (G), and blue (B) is formed. This color filter layer 32 is formed such that the color filter layer of each color of red (R), green (G), and blue (B) extends in a linear pattern in the column direction.

In addition, an overcoat layer 33 formed from a transparent resin is formed, so that the surfaces of the light shielding member 31 and the color filter layer 32 are coated therewith. On the surface of the overcoat layer 33, a second alignment film 37 is formed on the entirety of the surface of the color filter substrate CF. In addition, on the outer faces of the array substrate AR and the color filter substrate CF, polarizing plates 34 and 35, which are disposed in a cross Nicol arrangement, are disposed. Accordingly, this liquid crystal display panel 10A operates in a normally-black mode.

Any one of the array substrate AR and the color filter substrate CF is coated with the sealing member 13, and the array substrate AR and the color filter substrate CF are bonded together. Thereafter, the liquid crystal LC is injected from the liquid crystal injecting opening 14 formed from the sealing member 13, the liquid crystal injecting opening 14 is sealed with the sealing member 15, and integrated circuits DR such as drivers and the like are disposed in the mounting area 11a, thereby forming the liquid crystal display panel 10A according to the first embodiment.

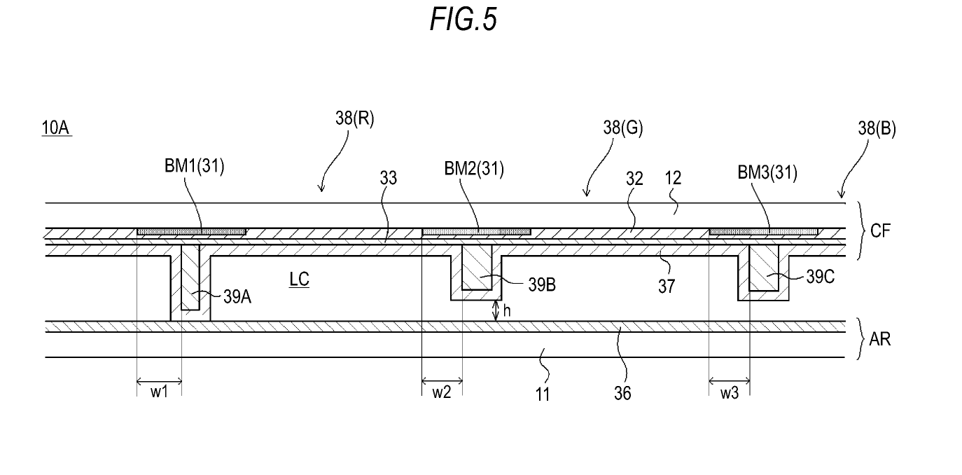

Next, detailed configurations of the light shielding member 31 and the columnar spacers of the liquid crystal display panel 10A according to the first embodiment will be described with reference to FIGS. 4 and 5. FIG. 4 is a plan view of one pixel (three sub pixels) of the liquid crystal display panel according to the first embodiment. FIG. 5 is a schematic cross-sectional view taken along line V-V shown in FIG. 4.

As shown in FIG. 4, on the array substrate AR, the scanning lines 16 and the signal lines 19 are formed in a matrix pattern in the display area DA, an area surrounded by the scanning lines 16 and the signal lines 19 forms one sub pixel, and one pixel is configured by adjacent sub pixels 38(R), 38(G), and 38(B) of three colors, for example, including red (R), green (G), and blue (B). In FIG. 4, an area denoted by dots represents the light shielding member 31 formed on the color filter substrate CF. The scanning lines 16, the signal lines 19, and the TFT are completely coated with the light shielding member 31 in the plan view, and the columnar spacers 39A, 39B, and 39C that are fixed to the color filter substrate CF side are also coated with the light shielding member 31 so as to be covered.

In the liquid crystal display panel 10A according to the first embodiment, a relatively thin columnar spacer 39A (hereinafter, referred to as a “first columnar spacer”) and columnar spacers 39B and 39C (hereinafter, referred to as “second columnar spacers”) that are thicker than the first columnar spacer 39A are shown. The first and second columnar spacers 39A, 39B, and 39C are not necessarily formed in each sub pixel but may be appropriately distributed and disposed in a range in which the cell gap between the array substrate AR and the color filter substrate CF is maintained to be constant, and good impact characteristics at low temperatures are acquired.

The liquid crystal display panel 10A according to the first embodiment represents a state in which leakage of light due to rubbing the first alignment film 36 of the opposing array substrate with the front end portions of the first and second columnar spacers 39A, 39B, and 39C is prevented, and, in order to secure a coating width that is necessary for the first and second columnar spacers 39A, 39B, and 39C, the light shielding member 31 is formed such that a part thereof intrudes into an adjacent sub pixel area.

In FIG. 5, reference numerals BM1 to BM3 represent the cross sections of the light shielding member 31 with which the first columnar spacers 39A and the second columnar spacers 39B and 39C are coated in the plan view. In FIG. 5, laminated members such as the scanning lines, the signal lines, the TFT, and various insulating films that are formed on the surface of the array substrate AR are not shown.

More specifically, the first columnar spacer 39A has a cylinder shape having a diameter of 12 μm, and the second columnar spacers 39B and 39C have the same cylinder shape having a diameter of 16 μm to 24 μm. In other words, a dimensional difference of a minimum of 4 μm to a maximum of 12 m is secured between the diameter of the first columnar spacer 39A and the diameter of the second columnar spacers 39B and 39C. By defining the diameters (or cross-sectional areas in the direction parallel to the color filter substrate CF) of the columnar spacers as above, manufacturing errors in the columnar spacers according to a photolithographic method can be absorbed, and the diameters of the second columnar spacers 39B and 39C can be formed to be markedly larger than the diameter of the first columnar spacer 39A. In addition, the difference in the heights of the first columnar spacer 39A and the second columnar spacer 39B and 39C, that is, a separation distance h between the surface of the alignment film 37 with which the second columnar spacers 39B and 39C are coated and the surface of the first alignment film 36 on the array substrate AR is set to 0.3 μm to 0.7 μm.

In addition, in the liquid crystal display panel 10A according to the first embodiment, the shape and the width of the light shielding member 31, with which the first columnar spacer 39A and the second columnar spacers 39B and 39C are coated in the plan view, as shown in FIG. 4, are the same near the columnar spacers of the sub pixels 38(R), 38(G), and 38(B). In other words, in FIG. 5, all the widths BM1 to BM3 are the same.

Accordingly, shortest distances w2 and w3 between the second columnar spacers 39B and 39C and the peripheral edge portion of the light shielding member 31 in the plan view are shorter than the shortest distance w1 between the first columnar spacer 39A and the peripheral edge portion of the light shielding member 31. In the liquid crystal display panel 10A according to the first embodiment, the occurrence of the leakage of light due to rubbing the alignment film of the opposing substrate with the second columnar spacers is avoided, and, in order to improve the aperture ratio near the second columnar spacers, the columnar spacers are formed such that the difference between w1 and w2=w3 is stably in the range of 0.2 μm to 0.6 μm.

As above, in the liquid crystal display panel 10A according to the first embodiment, regarding the shortest distances between the first columnar spacer 39A and the second columnar spacers 39B and 39C and the peripheral edge portion of the light shielding member 31, with which the columnar spacers are coated, in the plan view, the shortest distances for the second columnar spacers 39B and 39C are shorter than the shortest distance for the first columnar spacer 39A. In related art, when pressure that is equal to or higher than predetermined pressure is applied to the array substrate AR and the color filter substrate CF, there are cases where the second columnar spacers 39B and 39C rub the surface of the first alignment film 36 of the array substrate AR in accordance with crush of the first columnar spacer 39A, and, it is understood that, also at this rubbed spot, the same leakage of light similar to that occurring at a spot at which the first columnar spacer 39A is formed occurs. Accordingly, in the related art, shortest distances between the first and second columnar spacers 39A, 39B, and 39C and the peripheral edge portion of the light shielding member 31, with which the columnar spacers are coated, in the plan view are the same.

However, since the front end portions of the second columnar spacers 39B and 39C are normally separated from the array substrate AR by a constant distance h, the distance at which the second columnar spacers 39B and 39C rub the first alignment film 36 of the array substrate AR is shorter than that in the case of the first columnar spacer 39A. Accordingly, the possibility of the leakage of light occurring near the second columnar spacers 39B and 39C is lower than that near the first columnar spacer 39A.

Thus, according to the liquid crystal display panel 10A of the first embodiment, the shortest distances between the second columnar spacers 39B and 39C and the peripheral edge portion of the light shielding member 31, with which the second columnar spacers are coated, in the plan view are set to be shorter than the shortest distance between the first columnar spacer 39A and the peripheral edge portion of the light shielding member 31, with which the first columnar spacer is coated, in the plan view. Accordingly, the area of the light shielding member 31, with which the second columnar spacers 39B and 39C are coated, in the plan view can be decreased. Therefore, according to the liquid crystal display panel 10A of the first embodiment, leakage of light and alignment disturbance due to rubbing of the surface of the first alignment film 36 with the second columnar spacers 39B and 39C can be suppressed, and the aperture ratio is improved.

### Second Embodiment

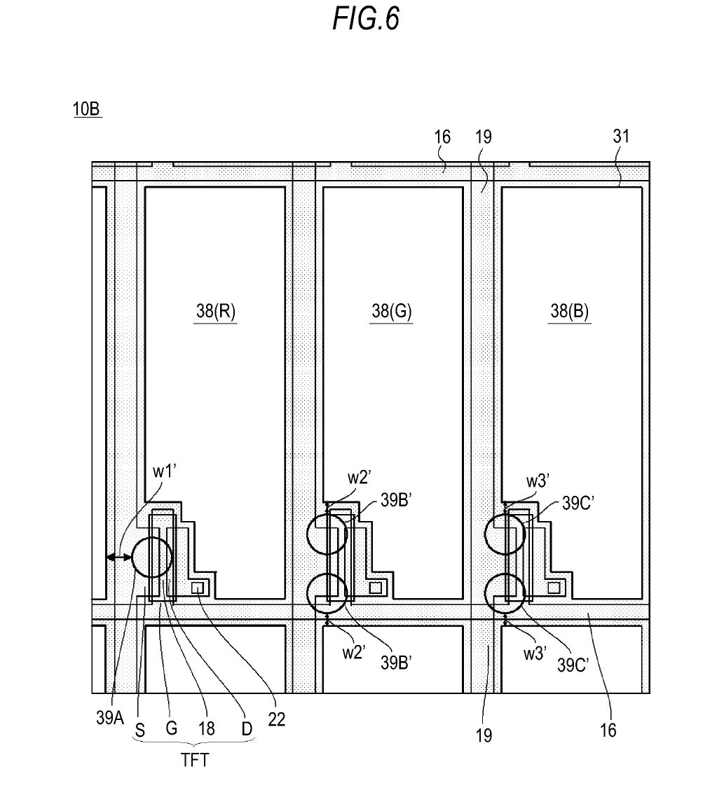

A liquid crystal display panel 10B according to a second embodiment will be described with reference to FIG. 6. FIG. 6 is a plan view of one pixel (three sub pixels) of the liquid crystal display panel 10B according to the second embodiment. The entire configuration of the liquid crystal display panel 10B according to the second embodiment is the same as that of the liquid crystal display panel 10A according to the first embodiment except for the configuration of the second columnar spacers. By citing FIGS. 1 to 3 for a specific configuration of the liquid crystal display panel 10B, a detailed description thereof will be omitted. In FIG. 6, the same reference numerals are assigned to portions that are the same as that of the liquid crystal display panel 10A according to the first embodiment, and a detailed description thereof will be omitted.

Differences between the liquid crystal display panel 10B of the second embodiment and the liquid crystal display panel 10A of the first embodiment are that, in the liquid crystal display panel 10B, each of the second columnar spacers of the sub pixels 38(G) and 38(B) is divided into two small-width second columnar spacers 39B′ and 39B′ or 39C′ and 39C′ having the same diameter and the light shielding member 31 is formed only in each sub pixel area without intruding into an adjacent sub pixel area.

Also in the liquid crystal display panel 10B according to the second embodiment, shortest distances w2′ and w3′ between the second columnar spacers 39B′, 39B′, 39C′ and 39C′ and the peripheral edge portion of the light shielding member 31 in the plan view are shorter than the shortest distance w1′ between the first columnar spacer 39A and the peripheral edge portion of the light shielding member 31. Also in the liquid crystal display panel 10B according to the second embodiment, the leakage of light occurring due to rubbing the first alignment film 36 of the opposing array substrate AR with the second columnar spacers 39B′, 39B′, 39C′ and 39C′ is avoided by the light shielding member 31, and, in order to improve the aperture ratio near the second columnar spacers 39B′, 39B′, 39C′ and 39C′, the columnar spacers are formed such that the difference between w1′, w2′, and w3′ is stably in the range of 0.2 μm to 0.6 μm.

However, both the sum of the cross-sectional areas of the small-width second columnar spacers 39B′ and 39B′ and the sum of the cross-sectional areas of the small-width second columnar spacers 39C′ and 39C′ are larger than the cross-sectional area of the first columnar spacer 39A. Accordingly, the small-width second columnar spacers 39B′ and 39B′ and the small-width second columnar spacers 39C′ and 39C′ can withstand stress more than the first columnar spacer.

According to the liquid crystal display panel 10B of the second embodiment in which two small-width second columnar spacers are disposed in each sub pixel area as above, the same advantages as those of the liquid crystal display panel 10A according to the first embodiment described above can be acquired. Furthermore, since each second columnar spacer is divided into two small-width second columnar spacers, even when the shortest distances between the small-width second columnar spacers 39B′, 30B′, 39C′, and 39C′ and the peripheral edge portion of the light shielding member in the plan view are the same as that in the case of one second columnar spacer, an area occupied by the surrounding light shielding member of the second columnar spacer can be decreased.

Thus, according to the liquid crystal display panel 10B of the second embodiment, the aperture ratio near the second columnar spacers 39B′, 39B′, 39C′, and 39C′ can be set higher than that of the liquid crystal display panel 10A of the first embodiment. Furthermore, since the diameter of each of the small-width second columnar spacers 39B′, 39B′, 39C′, and 39C′ is smaller than that of the first columnar spacer 39A, the disposition of the second columnar spacer can be determined more freely.

In the above-described liquid crystal display panels 10A and 10B according to the first and second embodiments, the case of the liquid crystal display panel of the horizontal electric field type that operates in the FFS mode has been described. However, an embodiment can be applied to a liquid crystal display panel of the horizontal electric field type that operates in an IPS mode and can be applied further to a liquid crystal display panel of the vertical electric field type. In addition, in the above-described liquid crystal display panels according to the first and second embodiments, an example in which all the first columnar spacer and the second columnar spacers are fixed to the color filter substrate side has been represented. However, even in a case where the first columnar spacer and the second columnar spacers are fixed to the array substrate, the same advantages can be acquired.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A liquid crystal display panel comprising:
one pair of substrates each of which is disposed so as to face each other with a liquid crystal layer pinched therebetween;
alignment films that are formed on opposing faces of the one pair of substrates with the liquid crystal layer pinched therebetween;
a plurality of columnar spacers that are formed in a display area on one side of the one pair of substrates and maintain a cell gap between the one pair of substrates; and
a light shielding member that is formed on one side of the one pair of substrates of a non-opening portion including a spot at which the columnar spacers are formed,
wherein the columnar spacers include a first columnar spacer that is disposed such that a front end portion of the first columnar spacer is normally brought into contact with the other side of the one pair of substrates and a second columnar spacer, which is lower than the first columnar spacer, having a front end portion that is normally separated from the other side of the one pair of substrates by a constant distance and is brought into contact with the other side of the one pair of substrates at time of application of pressure to one substrate of the one pair of substrates, and
wherein the light shielding member is formed such that a shortest distance between the second columnar spacer and a peripheral edge portion of the light shielding member in the plan view is shorter than a shortest distance between the first columnar spacer and the peripheral edge portion of the light shielding member in the plan view.

2. The liquid crystal display panel according to claim 1,
wherein a pixel electrode and a common electrode are formed below the alignment film on one substrate of the one pair of substrates.

3. The liquid crystal display panel according to claim 2,
wherein the pixel electrode and the common electrode are formed in a state of being insulated from each other with an inter-electrode insulating film pinched therebetween, and
wherein a slit-shaped opening is formed in one electrode of either the pixel electrode or of the common electrode that is closer to the alignment film.

4. The liquid crystal display panel according to claim 3,
wherein one electrode of either the pixel electrode or of the common electrode that is disposed on one substrate side of the inter-electrode insulating film is formed on an interlayer resin film that is formed on the one substrate of the one pair of substrates.

5. The liquid crystal display panel according to claim 1,
wherein a shortest distance between a peripheral edge portion of the light shielding member, with which the second columnar spacer is coated, and the second columnar spacer in the plan view is set to be shorter than a shortest distance between a peripheral edge portion of the light shielding member, with which the first columnar spacer is coated, and the first columnar spacer in the plan view by a distance that is equal to or greater than 2 μm and is equal to or less than 6 μm.

6. The liquid crystal display panel according to claim 1,
wherein a cross-sectional area of the second columnar spacer is larger than a cross-sectional area of the first columnar spacer.

7. The liquid crystal display panel according to claim 6,
wherein a plurality of the second columnar spacers are provided and each of the second columnar spacers has the same height, and
wherein a total cross-sectional area of the plurality of columnar spacers is set to be larger than the cross-sectional area of the first columnar spacer.
